(19) United States
(12) Patent Application Publication
(10) Pub. No.: US 2026/0161058 A1
(43) Pub. Date: Jun. 11, 2026

(54) FOLDABLE AUXILIARY SHOOTING STRUCTURE

(71) Applicant: TILTA INC., Burbank, CA (US)

(72) Inventors: Sen WU, Shenzhen (CN); Wenping ZENG, Shenzhen (CN); Kefeng ZHOU, Shenzhen (CN)

(21) Appl. No.: 19/048,645

(22) Filed: Feb. 7, 2025

(30) Foreign Application Priority Data
Dec. 9, 2024 (CN) 2024230335291

(51) Int. Cl. G03B 17/56

(52) U.S. Cl. CPC G03B 17/563; G03B 17/561

(57) ABSTRACT

The present application introduces a foldable auxiliary shooting structure including a first handheld component, a second handheld component, a connecting section, and a plurality of locking components. The connecting section is hinged at two ends that are connected to the first handheld component and the second handheld component, respectively. The locking components are operable to lock or unlock the first handheld component and the second handheld component, thereby enabling the first handheld component and the second handheld component to be in a use state or folded relative to the connecting section.

### CROSS-REFERENCE TO RELATED APPLICATIONS

The present application for patent claims priority to and the benefit of pending Chinese Application No. 2024230335291, filed December 09, 2024, and hereby expressly incorporated by reference herein as if fully set forth below in its entirety and for all applicable purposes.

### TECHNICAL FIELD

The present disclosure pertains to the technical field of photographic accessories, specifically to a foldable auxiliary shooting structure.

### INTRODUCTION

In the realm of videography, photography, and related shooting tasks, various shooting tools, such as stabilizers, are commonly utilized. When equipped with accessories for shooting equipment, the stabilizer's weight increases. Currently, users typically mount the stabilizer onto a handheld ring. While existing handheld rings enhance user shooting convenience, they occupy a significant volume and are cumbersome for carrying.

### BRIEF SUMMARY

The present disclosure introduces a foldable auxiliary shooting structure. When storage is required, manipulating the locking components allows a first handheld component and a second handheld component to be unlocked, reducing the overall volume occupied by the auxiliary shooting structure and making it more portable for users.

The present disclosure presents a foldable auxiliary shooting structure, including:

a first handheld component and a second handheld component;

a connecting section, with two ends hinged to the first handheld component and the second handheld component, respectively; and

multiple locking components, capable of locking or unlocking the first handheld component and the second handheld component, thereby positioning the first handheld component and the second handheld component in a use state or folded relative to the connecting section.

### Beneficial Effects

In the present disclosure, the first handheld component and the second handheld component can be movably connected to the connecting section, facilitating a switch between the use state and a folded state. During use, the locking components secure the first handheld component and the second handheld component in respective use positions, enhancing user operability. When storage is required, manipulating the locking components allows the first handheld component and the second handheld component to be unlocked, reducing the overall volume occupied by the auxiliary shooting structure and making it more portable for users.

### BRIEF DESCRIPTION OF THE DRAWINGS

To elucidate the technical solutions presented in the embodiments of the present application or the prior art, the accompanying drawings necessary for describing these embodiments or the prior art will be briefly introduced below. It is apparent that the accompanying drawings described herein represent merely some embodiments of the present application. For those skilled in the art, without the necessity for inventive effort, other drawings can be derived based on the structures depicted in these drawings.

FIG. 1 a diagram illustrating an auxiliary shooting structure according to some aspects of the disclosure.

FIG. 2 a diagram illustrating a foldability of the auxiliary shooting structure according to some aspects of the disclosure.

FIG. 3 a diagram illustrating an exploded view of the auxiliary shooting structure according to some aspects of the disclosure.

FIG. 4 a diagram illustrating a partial sectional view of the auxiliary shooting structure according to some aspects of the disclosure.

FIG. 5 a diagram illustrating an enlarged view of section A in FIG. 4.

FIG. 6 a diagram illustrating a mounting base.

FIG. 7 a diagram illustrating a sectional view of a foot stand according to some aspects of the disclosure.

Reference numerals of elements in the drawings:

10. auxiliary shooting structure;

1. first handheld component; 11. first handle portion; 111. first top threaded connection bayonet; 112. first bottom threaded connection bayonet; 12. first pipe; 13. second pipe; 14. first alloy sleeve; 15. first disk; 16. first threaded connection bayonet; 17. foot stand; 171. connecting portion; 1711. limiting hole; 1712. electrical port; 1713. circuit board; 1714. contact pin; 172. foot support portion; 1721. button; 1722. limiting part; 18. pivot; 19. wiring channel;

2. second handheld component; 21. second handle portion; 22. third pipe; 23. fourth pipe; 24. second alloy sleeve; 25. second disk; 26. second threaded connection bayonet; 27. second limiting part;

3. Connecting section; 31. Wiring through-hole;

4. Locking component; 41. First limiting part;

5. Stabilizer mounting component; 51. Mounting base; 52. Power supply interface;

6. Electrical connection line; 61. Elastic line portion;

7. Power supply component;

8. Connecting handle.

The objectives, functional characteristics, and advantages of the present invention will be further elucidated with reference to the embodiments and accompanying drawings.

### DETAILED DESCRIPTION

The subsequent passages provide a precise and exhaustive portrayal of the technical solutions embodied within this application, drawing upon the illustrative figures. It is to be understood that the enumerated embodiments constitute but a fraction of the broader scope and are not exhaustive. Consequently, any alternative embodiments derived by ordinary technicians in the relevant field, without the necessity for inventive ingenuity, are encompassed within the protective ambit of this application.

In the present disclosure, directional terminology (e.g., up, down, left, right, front, rear, etc.) serves exclusively to elucidate the relative positional arrangements and dynamic states among components within a specific orientational framework as depicted in the drawings. In the event of a change in this orientational framework, the directional designations will naturally align with the new configuration.

Furthermore, the utilization of ordinal indicators such as "first," "second," and so forth, in this application, is purely for descriptive clarity and cannot be misconstrued as signifying relative significance or implicitly indicating the number of technical features referenced. As such, expressions constrained by such ordinal designations may encompass one or more of the indicated features, either explicitly or implicitly. Moreover, the phrase "and/or" used throughout this document encompasses three distinct possibilities: Taking A and B as examples, it embraces the technical solution exclusive to A, the technical solution exclusive to B, as well as the technical solution that concurrently satisfies both A and B. Additionally, the integration of technical solutions across distinct examples is permissible, albeit contingent upon the feasibility of such integration by ordinary technicians in the field. In instances where the combined technical solutions conflict or are unfeasible, such integrations are deemed non-existent and thereby excluded from the scope of protection afforded by this application.

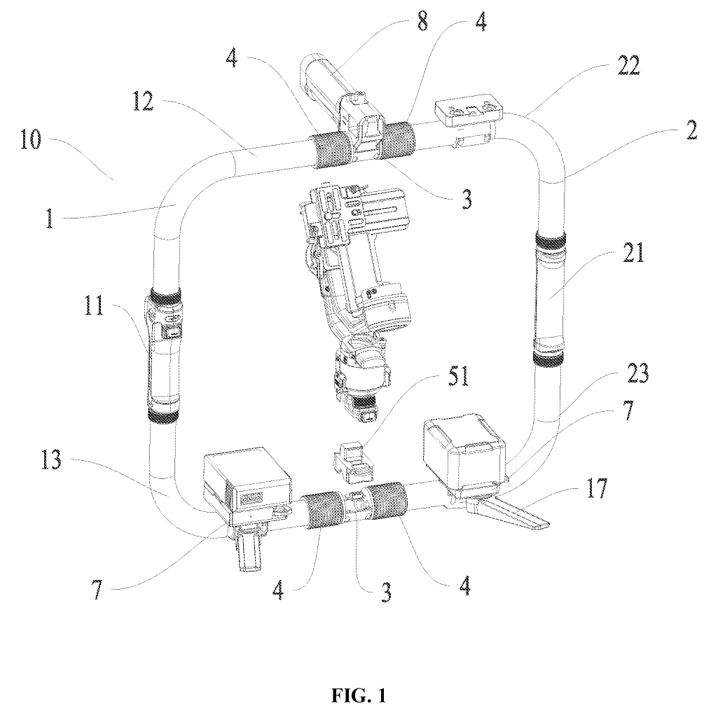

Referring to FIGS. 1-7, the present application introduces a foldable auxiliary shooting structure 10 including a first handheld component 1, a second handheld component 2, a connecting section 3, and multiple locking components 4. The connecting section 3 is hinged at two ends to the first handheld component 1 and the second handheld component 2, respectively. The locking components 4 are capable of locking or unlocking the first handheld component 1 and the second handheld component 2, thereby allowing the first handheld component 1 and the second handheld component 2 to be in a use state or folded relative to the connecting section 3.

This configuration enables the first handheld component 1 and the second handheld component 2 to be movably connected to the connecting section, facilitating a switch between the use state and a folded state. During use, the locking components secure the first handheld component 1 and the second handheld component 2 in respective use positions, enhancing user operability. When storage is required, manipulating the locking components 4 allows the first handheld component 1 and the second handheld component 2 to be unlocked, reducing the overall volume occupied by the auxiliary shooting structure 10 and making it more portable for users.

Alternatively, the first handheld component 1 and the second handheld component 2 are configured to fold towards a same side relative to the connecting section 3 when in a folded state.

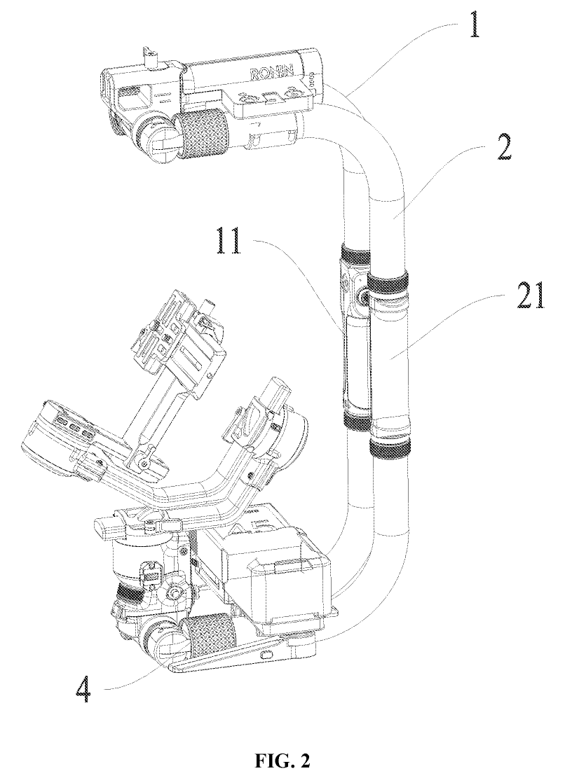

In one embodiment, please refer to FIGS. 1-2. When the auxiliary shooting structure 10 is configured as a ring handle, the connecting section 3 includes multiple connecting sections for left-right folding of the ring handle. Specifically, one connecting section 3 has two ends hinged to a first end of the first handheld component 1 and a first end of the second handheld component 2, respectively, while another connecting section 3 has two ends hinged to a second end of the first handheld component 1 and a second end of the second handheld component 2, respectively. Each connecting section 3 cooperates with two of the locking components 4. In this embodiment, four locking components 4 may be required. By manipulating these four locking components 4, the positions of both ends of the first handheld component 1 relative to the connecting section 3 and the positions of both ends of the second handheld component 2 relative to the connecting section 3 can be unlocked. This allows the first handheld component 1 and the second handheld component 2 to fold relative to the connecting section 3, as shown in FIG. 2.

Alternatively, when the auxiliary shooting structure 10 is in the form of a ring handle, ends of the first handheld component 1 and the second handheld component 2 distant from the connecting section 3 are detachably connected or hinged. In this way, unlocking the two locking components 4 corresponding to one connecting section 3 enables the other ends of the first handheld component 1 and the second handheld component 2 to be detached or rotated, thereby folding the ring handle.

Referring to FIG. 2, one of the locking components 4 is mounted on the first handheld component 1, while another is mounted on the second handheld component 2. The locking components 4 can be tightened onto or unlocked from the connecting section 3 to position the first handheld component 1 and the second handheld component 2 in a use state or folded relative to the connecting section. Specifically, two ends of the connecting section 3 feature external threads, while the locking components 4 have internal threads. When the locking components 4 are loosened and moved away from the connecting section 3, the first handheld component 1 and the second handheld component 2 can fold relative to the connecting section 3.For storage and ease of carrying, users can rotate the locking components 4 on the top and bottom of the ring handle so that the locking components 4 move towards the first handheld component 1 and the second handheld component 2, respectively. Subsequently, users can use both hands to pull the first handheld component 1 and the second handheld component 2, allowing the first handheld component 1 and the second handheld component 2 to move relative to the connecting section 3 for folding. During use, the first handheld component 1 and the second handheld component 2 are spread apart and aligned, and then the locking components 4 are tightened to secure the locking components 4 onto the connecting section 3 with threaded connection, transitioning to the usage state. Notably, the locking components 4 are equipped with a first limiting part 41, while the first handheld component 1 and the second handheld component 2 are correspondingly equipped with a second limiting part 27. When the locking components 4 are rotated to lock, the second limiting part 27 restricts the movement of the first limiting part 41.

Alternatively, two locking components 4 are sleeved on two ends of the connecting section 3. These locking components 4 can be tightened with or unlocked from the first handheld component 1 and the second handheld component 2, respectively, thereby placing the first handheld component 1 and the second handheld component 2 in a use state or folded relative to the connecting section 3. Notably, the locking mechanism of the locking components 4 can refer to the aforementioned principle and will not be further elaborated here.

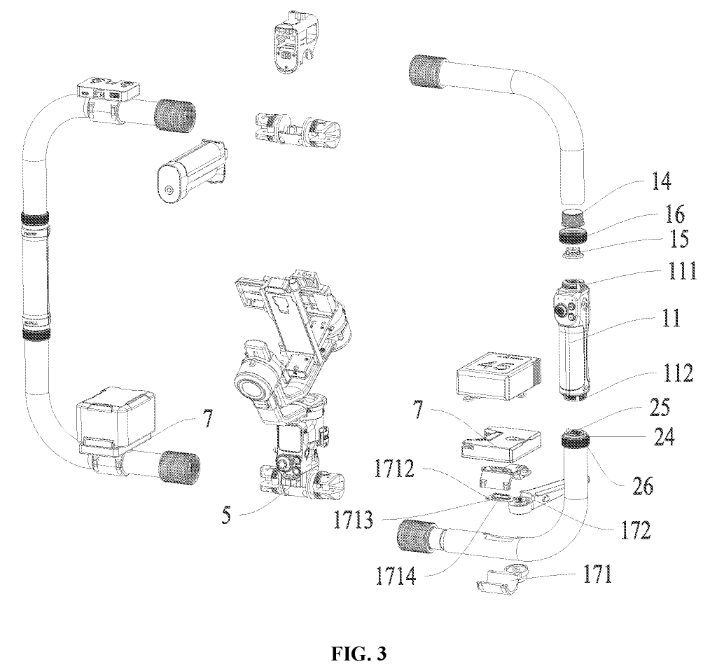

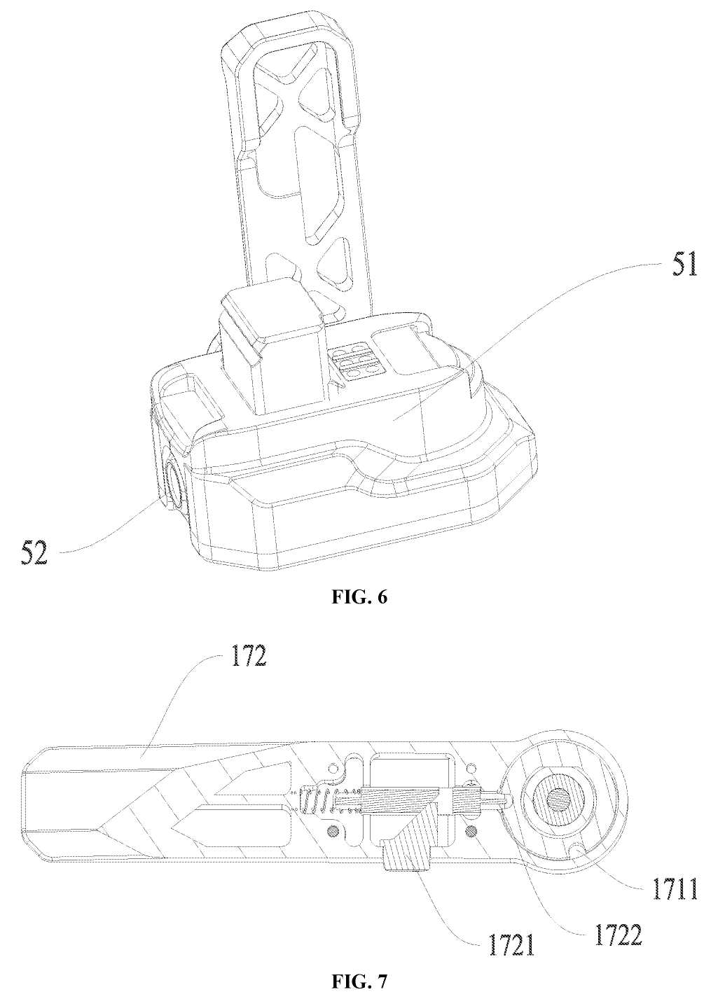

Referring to FIG. 3 and FIG. 6, the auxiliary shooting structure 10 described in the present disclosure also includes a stabilizer mounting component 5, an electrical connection line 6, and a power supply component 7. The power supply component 7 is disposed within at least one of the first handheld component 1, the second handheld component 2, and the stabilizer mounting component 5. The stabilizer mounting component 5 is located on the connecting section 3, and at least one of the stabilizer mounting component 5 and the power supply component 7 is electrically connected to the electrical connection line 6. Specifically, the auxiliary shooting structure 10 in this disclosure employs an internal wiring configuration. For instance, the electrical connection line 6 is disposed within the auxiliary shooting structure 10, and the stabilizer mounting component 5 is mounted on the connecting section 3 and can be electrically connected to the electrical connection line 6. Specifically, for instance, the stabilizer mounting component 5 may include a mounting base 51 installed on the connecting section 3 for mounting the stabilizer. The stabilizer and the mounting base 51 can be electrically connected via contact pins 1714. The mounting base 51 may incorporate a circuit board 1713 within the connecting section 3, and the electrical connection line 6 can be welded to the circuit board 1713 to establish electrical connectivity. Specifically, the electrical connection line 6 may include multiple wires connected in parallel or in series in an electrically connected manner. It is noteworthy that the power supply component 7 can include a power supply interface 52 disposed on the mounting base 51 for connecting an external power source to provide power to the mounting base 51. Alternatively, the power supply component 7 can include a battery mount located on either the first handheld component 1 or the second handheld component 2, which can be connected to the power supply interface 52 on the mounting base 51 via a data cable. Power can then be supplied to the stabilizer through the mounting base 51 and to other electrically connected structures on the auxiliary shooting structure 10 via the power supply base and the electrical connection line 6. As another option, the power supply component 7 can be electrically connected to the electrical connection line 6, with the power supply component 7 connecting to an external battery or housing an internal battery, and then supplying power to the stabilizer mounting component 5 and other electrically connected structures on the auxiliary shooting structure 10 through the internal wiring configuration.

The first handheld component 1 and the second handheld component include handle portions configured to be electrically connected to at least one of the stabilizer mounting component 5 and the power supply component 7 via the electrical connection line 6. Specifically, the first handheld component 1 includes a first handle portion 11, a first pipe 12, and a second pipe 13, while the second handheld component 2 includes a second handle portion 21, a third pipe 22, and a fourth pipe 23. Specifically, the adjacent ends of the first pipe 12 and the third pipe 22 are hingedly connected to opposite ends of the connecting section 3, respectively, while their distal ends are joined by a first alloy sleeve 14. Screws pass through a first disk 15 and engage with a first threaded connection bayonet 16 to secure the first alloy sleeve 14. One end of the first disk 15 is linked to an electrical connection line 6. The electrical connection line 6 traverses the first pipe 12 and the third pipe 22 to connect with an upper electrical port 1712. Similarly, the adjacent ends of the second pipe 13 and the fourth pipe 23 are hingedly connected to the connecting section 3, with their distal ends joined by a second alloy sleeve 24. Screws pass through a second disk 25 and engage with a second threaded connection bayonet 26 to secure the second alloy sleeve 24. One end of the second disk 25 is connected to the electrical connection line 6. The electrical connection line 6 traverses the second pipe 13 and the fourth pipe 23 to connect with the same upper electrical port 1712.

The first handle portion 11 and the second handle portion 21 can be optionally configured as simple handles, dual-follow-focus handles, or stabilizer control handles. Specifically, the simple handle includes a first top threaded connection bayonet 111 and a first bottom threaded connection bayonet 112, solely serving as a gripping handle. The dual-follow-focus handle also includes a first top threaded connection bayonet 111 and a first bottom threaded connection bayonet 112, along with an internal control terminal and a built-in power drive. Additionally, it features a handwheel capable of wirelessly controlling two motors mounted on the camera lens. By rotating the handwheel, the motors' rotation can be adjusted, facilitating focusing and zooming operations by altering the lens' focal length area. Similarly, the stabilizer control handle includes a first top threaded connection bayonet 111 and a first bottom threaded connection bayonet 112, an internal control terminal, and a built-in power drive. The stabilizer control handle also incorporates a joystick and a handwheel. The stabilizer control handle wirelessly connects to the stabilizer, allowing the user to manipulate the joystick to control the stabilizer's rotation along two axes, thereby adjusting the camera's orientation for the desired shot. The handwheel controls the motor connected to the camera lens, adjusting the lens' focal length area for focusing and zooming. Furthermore, the first top threaded connection bayonets 111 align with the first threaded connection bayonets 16 of the first pipe 12 and the third pipe 22 for installation. Similarly, the first bottom threaded connection bayonets 112 align with the second threaded connection bayonets 26 of the second pipe 13 and the fourth pipe 23 for installation. By rotating the first threaded connection bayonets 16 of the upper ring pipe and the second threaded connection bayonets 26 of the lower ring pipe, the ring pipe body connects to the left and right handles, forming a complete closed loop.

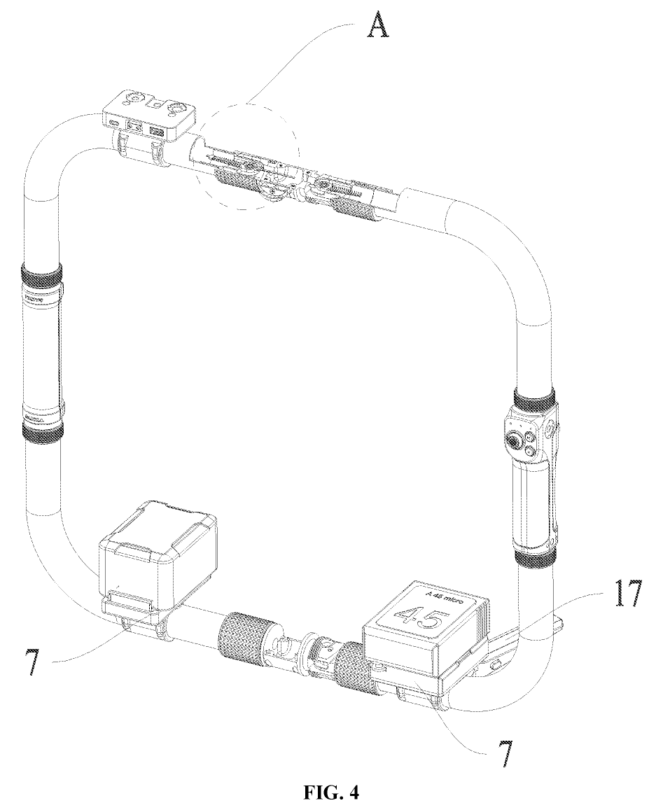

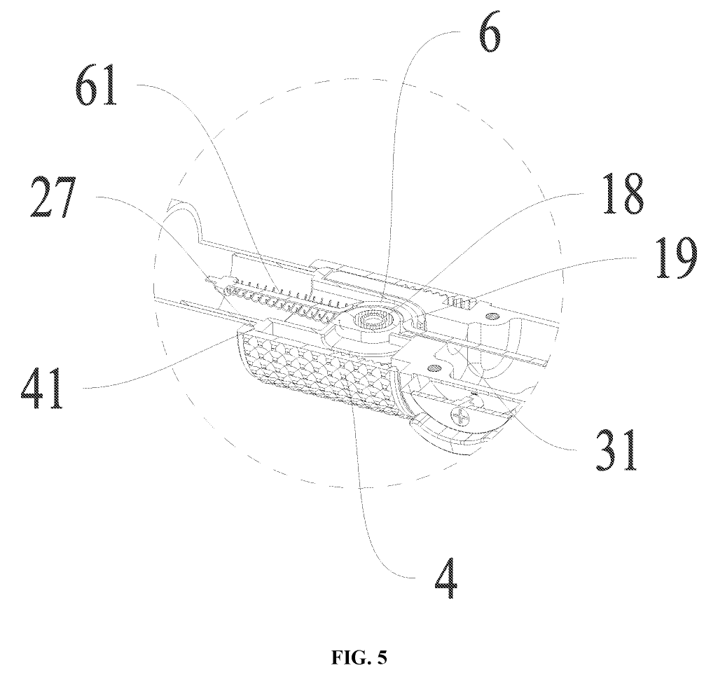

Regarding the internal wiring at the connection points between the connecting section 3 and the pipes 12, 13, 22, and 23, please refer to FIGS. 4-5. This disclosure reveals two ends of the connecting section 3 and the first handheld component 1 and the second handheld component 2 are connected via pivots 18. Wiring channels are disposed around the pivots 18 of the first handheld component 1 and the second handheld component 2, and wiring through-holes are located at two ends of the connecting section 3, allowing the electrical connection line 6 to pass from inside the connecting section 3 to inside the first handheld component 1 and the second handheld component 2. Taking the electrical connection line 6 within the first pipe 12 and third pipe 22 as examples, the same principle applies to the electrical connection line 6 within the second pipe 13 and fourth pipe 23. The first pipe 12 and third pipe 22 are hinged to the connecting section 3 at two ends via pivots 18, with wiring channels 19 set around the outer edges of the pivots 18. The electrical connection line 6 within the connecting section 3 extends into the first pipe 12 and third pipe 22 through corresponding wiring channels 19 and wiring through-holes 31. Notably, the electrical connection line 6 includes an elastic line portion 61 to accommodate the first handheld component 1 and the second handheld component 2 for folding relative to the connecting section 3.

Alternatively, both the first handheld component 1 and the second handheld component 2 are provided with foot stands 17. These foot stands 17 include connecting portions 171 and foot support portions 172. The two connecting portions 171 are connected to the first handheld component 1 and the second handheld component 2, respectively, and corresponding foot support portions 172 are movably connected to the connecting portions 171 and can rotate relative to the connecting portions 171. When the first handheld component 1 and the second handheld component 2 are folded, the foot support portion 172 can also fold relative to the connecting portion 171 for storage.

Specifically, referring to FIGS. 3 and 7. The foot support portion 172 and the connecting portion 171 are hinged together. Multiple limiting holes 1711 are disposed on the outer circumference of the connecting portion 171. The foot support portion 172 includes a button 1721 and a limiting part 1722. The limiting part 1722 is elastically mounted on the foot support portion 172, specifically connected via a spring, and engages with the inclined surface of the button 1721. Upon pressing the button 1721, the limiting part 1722 can disengage from the limiting hole 1711 due to the pressing action of the inclined surface, allowing the foot support portion 172 to rotate for opening or folding. Two of the limiting holes 1711 correspond to the positions where the foot support portion 172 is fully opened and fully folded, respectively. Notably, the connecting portion 171 is connected to the first handheld component 1 and/or the second handheld component 2 and features an electrical port 1712. The electrical port 1712 includes a circuit board 1713 connected to the electrical connection line 6 and contact pins 1714 connected to the circuit board 1713. The power supply component 7 or other electrical accessories can connect to the electrical port 1712 via the contact pins 1714.

In one aspect, the power supply component 7 can incorporate an Anton battery power supply module and a V-mount battery power supply module. The Anton battery power supply module supplies power by accommodating an Anton battery, while the V-mount battery power supply module supplies power by accommodating a V-mount battery. The aforementioned power supply method can either provide power to the mounting base 51 of the stabilizer mounting component 5 and subsequently to other structures such as the handle through internal wiring, or directly provide power to the stabilizer mounting component 5 and handle through internal wiring.

It is emphasized that the aforementioned embodiments serve as preferred illustrations and do not constitute limitations on the scope of the patent claims presented herein. Any structural modifications that are deemed equivalent, based on the disclosure and drawings of this application, or their direct/indirect application in related technical domains, fall within the ambit of patent protection afforded to this application, in line with its underlying concept.

What is claimed is:

1. A foldable auxiliary shooting structure, comprising:
a first handheld component;
a second handheld component;
a connecting section, a first end of the connecting section hinged to the first handheld component and a second end of the connecting section hinged to the second handheld component; and
a plurality of locking components operable to transition the first handheld component and the second handheld component between a use state or a folded state relative to the connecting section.

2. The foldable auxiliary shooting structure according to claim 1, wherein the connecting section comprises a plurality of connecting sections;
wherein a first connecting section of the plurality of connecting sections comprises two ends hinged to a first end of the first handheld component and a first end of the second handheld component, respectively, and a second connecting section of the plurality of connecting sections comprises two ends hinged to a second end of the first handheld component and a second end of the second handheld component, respectively; and
wherein each of the plurality of connecting sections cooperates with two of the plurality of locking components to transition the first handheld component and the second handheld component between a lock state and an unlock state.

3. The foldable auxiliary shooting structure according to claim 1, wherein an end of the first handheld component distant from the connecting section and an end of the second handheld component distant from the connecting section are detachably connected or hinged.

4. The foldable auxiliary shooting structure according to claim 2, wherein the first handheld component and the second handheld component are configured to fold towards a same side relative to the connecting section when in the folded state.

5. The foldable auxiliary shooting structure according to claim 1, wherein a first locking component of the plurality of locking components is provided on the first handheld component, and a second locking component of the plurality of locking components is provided on the second handheld component; and
wherein the first locking component and the second locking component are operable to transition between a locking state and un unlocking state with the connecting section to selectively position the first handheld component and the second handheld component in the use state or the folded state relative to the connecting section.

6. The foldable auxiliary shooting structure according to claim 5,
wherein the connecting section comprises a first end and a second end, each end comprising an external thread;
wherein the first locking component and the second locking component each comprise an internal thread; and
wherein the first handheld component and the second handheld component are operable to fold relative to the connecting section when the first locking component and the second locking component are loosened and moved away from the connecting section,.

7. The foldable auxiliary shooting structure according to claim 1, wherein two of the plurality of locking components are respectively sleeved on two ends of the connecting section; and
wherein the two of the plurality of locking components are operable to transition the first handheld component and the second handheld component between a lock state and an unlocked state, enabling the first handheld component and the second handheld component to selectively be in a use state or a folded state relative to the connecting section.

8. The foldable auxiliary shooting structure according to claim 1, further comprising:
a stabilizer mounting component, an electrical connection line, and a power supply component;
wherein the power supply component is provided on at least one of the first handheld component, the second handheld component, or the stabilizer mounting component; and
wherein the stabilizer mounting component is located on the connecting section, and at least one of the stabilizer mounting component or the power supply component is electrically connected to the electrical connection line.

9. The foldable auxiliary shooting structure according to claim 8, wherein the first handheld component and the second handheld component each comprise a handle portion configured to be electrically connected to at least one of the stabilizer mounting component pr the power supply component via the electrical connection line.

10. The foldable auxiliary shooting structure according to claim 8, wherein a first end of the connecting section is connected to the first handheld component via a pivot, and a second end of the connecting section is connected to the second handheld component via a pivot; and
wherein the first handheld component and the second handheld component are each provided with a wiring channel around the corresponding pivot, and each end of the connecting section is provided with a wiring through-hole, enabling the electrical connection line to pass from inside the connecting section to inside the first handheld component and the second handheld component.

11. The foldable auxiliary shooting structure according to claim 10, wherein the electrical connection line comprises an elastic line portion configured to accommodate folding movements between the first handheld component and the second handheld component relative to the connecting section.

12. The foldable auxiliary shooting structure according to claim 1, wherein the first handheld component comprises a first foot stand, and the second handheld component comprises a second foot stand;
wherein the first foot stand comprises a first connecting portion and a first foot support portion;
wherein the second foot stand comprises a second connecting portion and a second foot support portion;
wherein the connecting portion comprises a first connecting portion connected to the first handheld component and a second connecting portion connected to the second handheld component; and
wherein first foot support portion and the second foot support portion are movably connected to the corresponding connecting portions and operable to rotate relative to the connecting portions.
